(19) United States
(12) Patent Application Publication
(10) Pub. No.: US 2016/0103778 A1
(43) Pub. Date: Apr. 14, 2016

(54) MEMORY COMPONENT CAPABLE TO COMMUNICATE AT MULTIPLE DATA WIDTHS

(71) Applicant: Hewlett-Packard Development Company, L.P., Houston, TX (US)

(72) Inventors: Gregg B. Lesartre, Fort Collins, CO (US); Martin Foltin, Fort Collins, CO (US); Gary Belgrave Gostin, Irving, TX (US)

(73) Assignee: Hewlett-Packard Development Company, L.P., Houston, TX (US)

(21) Appl. No.: 14/786,923

(22) PCT Filed: Jun. 28, 2013
(86) PCT No.: PCT/US2013/048777

§ 371 Date: Oct. 23, 2015

(51) Int. Cl. G06F 13/40; G06F 12/06; G06F 13/16; G06F 12/02

(52) U.S. Cl. CPC G06F 13/4018; G06F 12/023; G06F 12/0646; G06F 13/1694; G06F 13/1678; G06F 2212/1044; G06F 2212/2515

(57) ABSTRACT

Examples disclose a method, memory component, and storage medium to configure a data width of the memory component. The examples disclose receiving a configuration transaction at the memory component capable to communicate at multiple data widths. Additionally, the examples disclose configuring the data width of the memory component based on the configuration transaction.

### BACKGROUND

Memory system storage may be utilized to read and write various values of data. The memory components in these systems are generally of fixed data width to perform the operations of reading and writing data values.

### BRIEF DESCRIPTION OF THE DRAWINGS

In the accompanying drawings, like numerals refer to like components or blocks. The following detailed description references the drawings, wherein:

FIG. 1 is a block diagram of an example interface and memory component including a controller to receive a configuration transaction associated with a number of data bits, a register to set an internal value corresponding to the number of data bits, and an array to provide values of the number of data bits;

FIG. 2A is a block diagram of an example memory controller including interfaces to multiple memory components;

FIG. 2B is a block diagram of an example memory component including multiple memory elements;

FIG. 3 is a flowchart of an example method to receive a configuration transaction and configure a data width of a memory component based on the configuration transaction;

FIG. 4 is a flowchart of an example method to receive a configuration transaction associated with a number of data bits and configure a data width of a memory component by setting an internal register of the memory component to a value corresponding to the number of data bits;

FIG. 5 is a flowchart of an example method to receive a configuration transaction, configure a data width of the memory component based on the configuration transaction, configure a second data width, and collect values of data bits corresponding to the second configured data width, and transmit the collected values; and

FIG. 6 is a block diagram of an example computing device with a processor to execute instructions in a machine-readable storage medium for receiving a configuration transaction, configuring a data width for communication by setting a register to a value corresponding to the data width.

### DETAILED DESCRIPTION

Memory system components are traditionally designed with fixed data widths. Fixed data widths may limit the type of memory systems in which these memory components may be used. For example, standardized fixed data widths are provided by a manufacturer, but this limits the flexibility of the memory system as the data width is a static configuration. In another example, to change the data width of communication between components in the memory system, the memory system may need to be redesigned. This creates a more static and rigid approach to the memory system architectures. Further, fixed data widths may be inefficient as the utilized data width may be smaller in size than the fixed data width. In this example, much of the bandwidth may be under-utilized.

To address these issues, examples disclosed herein provide a method to configure a data width of a memory component. Data width as defined herein is a data operand size in the number of bits of a read or write transaction, rather than the width of the data bus of the memory component. The method receives a configuration transaction at a memory component which may configure the memory component to access data at various data widths. The configuration transaction indicates to the memory component a specific data width by providing a number of bits corresponding to the specific data width. In another implementation, the configuration transaction indicates multiple data widths, such as a data transfer width and/or data access width. The data transfer width indicating the data width to be transferred to the system accessing the data and the data access width indicating a width of data to be accessed from memory arrays and processed to produce the data to be transferred to the system. Upon receiving the configuration transaction, the memory configures the specific data width. Receiving the configuration transaction corresponding to the specific data width provides a flexible approach in configuring the memory component. This further provides a dynamic approach in that the memory component may be configured to various data widths.

Additionally, configuring the data width of the memory component based on the configuration transaction may increase data communication speed to support future generations of memory architectures. Configuring the data width leads to higher efficiency as bandwidth may be dynamically adjusted to the specified data width which produces an overall lower power consumption of the memory component. For example, indicating the data width (i.e., data access) intended for all transactions rather than separately indicating the data width in each transaction results in a higher efficiency across the interface, leading to more bandwidth per lane, and lower power consumption per transaction.

In another implementation, the examples further provide a method to collect data bit values from memory elements and perform a correction function, such as an error correction code (ECC) on the collected values. Performing the correction function at the memory component prior to transmission provides fewer data bit values for transmission. Additionally, performing the correction function at the memory component ensures the transmitted data bit values are without corruption.

In summary, examples disclosed herein provide a flexible approach by configuring a data width of a memory component based on a configuration transaction. Additionally, the examples disclosed herein lead to higher efficiency by dynamically adjusting the data width of the memory component.

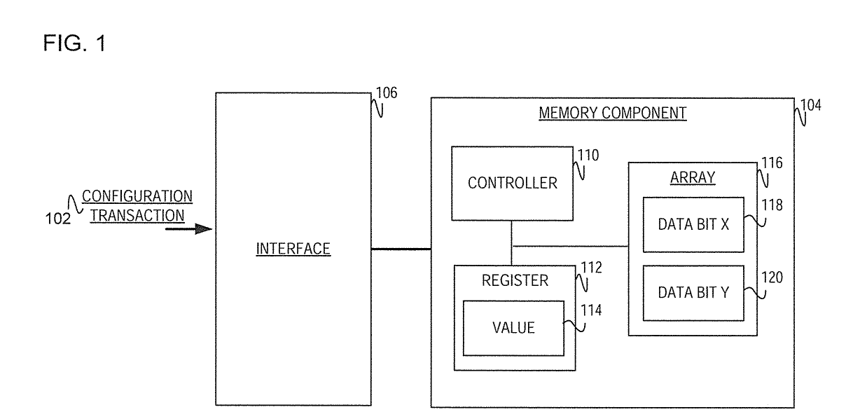

Referring now to the figures, FIG. 1 is a block diagram of an interface 106 and memory component 104. The memory component 104 includes an internal controller 110 to receive a configuration transaction 102 across the interface 106. The configuration transaction 102 provides a value 114 to memory component 104 to set into an internal register 112. The value 114 corresponds to the data width or data operand size to be used for subsequent memory access transactions, such as read or write transactions. In this manner, the value 114 provided in the configuration transaction 102 indicates the width of the data access. The memory component 106 further includes an array 116 to read and/or write various bits of data 118 and 120.

The interface 106 transmits configuration transactions and other memory access transactions, such as read and write operations to the memory component 104. In one implementation, the interface 106 is a hardware type of interface which transmits the configuration transaction 102 from a controller external (not illustrated) to the memory component 104. In another implementation, the interface 106 may include a set of instructions, process, operation, logic, algorithm, technique, logical function, firmware, and/or software for providing communication between the external controller and the memory component 104. The external controller is in communication with an operating system, management software, or hardwired modes for configuring the size of the data width of the memory component 104. The interface 106 receives logical signals and a protocol for sequencing the logical signals and/or transactions to ensure the signals are routed to the given component. As such, implementations of the interface 106 may include a small computer system interface (SCSI), internet small computer system interface (iSCSI), serializer/deserializer (SerDes), or other type of interface capable of receiving signals and/or transactions and routing accordingly. In one implementation, an administrator may pre-define the data width for a configuration transaction which may originate at the external controller for transmission to the memory component 104. In another implementation, the interface 106 includes a serializer/deserializer (SerDes) for high speed communication between the memory component 104 and other components connected to the interface 106. In this implementation, the interface 106 includes functional hardware interface modules to convert data between serial data and/or parallel data. For example, the interface 106 may receive and/or transmit the configuration transaction 102 and other data serially and/or in parallel. In a further implementation, the interface 106 may include a narrow interface which may take twice the number of cycles to transmit the data on the channel(s) while in yet a further implementation, the interface 106 may include a wide interface.

The configuration transaction 102 specifies the number of data bits which corresponds to the data width. Specifically, the configuration transaction 102 is the transaction which sets the data width of the memory component 104. Additional transactions or operations indicating a memory location or address to access to read or write data values may be received by the memory component 104 once the data width has been configured by the configuration transaction 102. The data width indicates to the memory component 104 and/or the interface 106 the number of data bit values which may be read or written in the given read or write operation. The given read or write operations may be communicated on communication channels within the memory component 104. These communication channels are configured in addition to the data width of the memory component 104. This implementation is discussed in detail in the next figure. In another implementation, the memory component 104 may receive additional transactions (e.g., read operations to access a number of data bits matching the configured data width from the array 116 and/or write operations which include a number of data bits corresponding to the configured data width to be provided to the array 116). These additional transactions are considered different from the configuration transaction 102 in that the configuration transaction 102 configures the data width of the memory component 104 corresponding to the read and/or write operations. For example, the configuration transaction 102 sets the data width value 114 in register 112 of the memory component 104, while the additional operations read and write data values using the data width specified by value 114 in register 112. In another example, the configuration transaction 102 may include an address configuration which indicates how the address provided in read and write transactions should be interpreted to select the memory elements in the component 104 to access.

The memory component 104 is a storage area capable of communication at multiple data widths. The memory component 104 receives the configuration transaction 102 and interprets the transaction 102 for configuring the data width. The memory component 104 is capable of communication at multiple data widths, thus receiving the configuration transaction 102 enables the memory component 104 to dynamically adjust a data width according to the number of data bits indicated in the configuration transaction 102. Embodiments of the memory component include non-volatile memory, volatile memory, dual-in-line memory module, read-only memory (ROM), flash memory, ferroelectric random access memory (RAM), floppy disk, magnetic tape, optical disk, hard drive, magnetoresistive random memory (MRAM), nanodrive, solid state drive, memory mapped storage (MMS), or other suitable memory component capable of communication at multiple sizes of data widths.

The controller 110 is an electronic device internal to the memory component 104 which manages the operations of the memory component 104 to read and/or write data bit values to the array 116. The controller 110 manages the internal operations of the memory component 104 and as such, operates as the interface between the memory component 104 and external components. The controller is connected to the interface 106 to receive the configuration transaction 102 and configure the width of the data access to the array 116 according to the value 114 transmitted in the configuration transaction 102. Implementations of the internal controller 110 include an application-specific integrated circuit (ASIC), processor, microprocessor, microchip, chipset, electronic circuit, semiconductor, microcontroller, central processing unit (CPU), or other configurable device capable of managing various operations of the memory component 104.

The register 112 is a type of hardware register which stores a value 114 corresponding to the number of data bits associated with the configuration transaction 102. The value set at the register 112 indicates to the memory component 104 the width of the data access. The data width specifies how many bits of data which may be read and written into the array 116. In this manner, the number of data bits may which be read and/or written configures the width of the data access. The value 114 of the register 112 is set corresponding to the number of bits specified by the configuration transaction 102.

The array 116 is a collection of memory elements internal to the memory component which includes the various bits of data 118 and 120. As such, the array 116 may include various memory modules and/or memory elements as seen in the next figure. The term, memory element, as used herein may include referencing the storage of a single data bit. The various bits of data 118 and 120 represent the values of data bit values read or written into the array 116. Reading the various values of data bits in the array 116 may include observing the state of a memory array node. For example, data bit 118 may include “0,” as indicated with a low voltage stored at that location of the data bit while data bit 120 may include “1,” as indicated with a high voltage level stored. Writing various values of data bits to the array 116 may include energizing the array at a specified location to write the various data bit values 118 and 120. In a memristor application, the memory component may program a resistance value into each data bit based on a current through the data bit and adjust the resistance levels to correspond to data bit values.

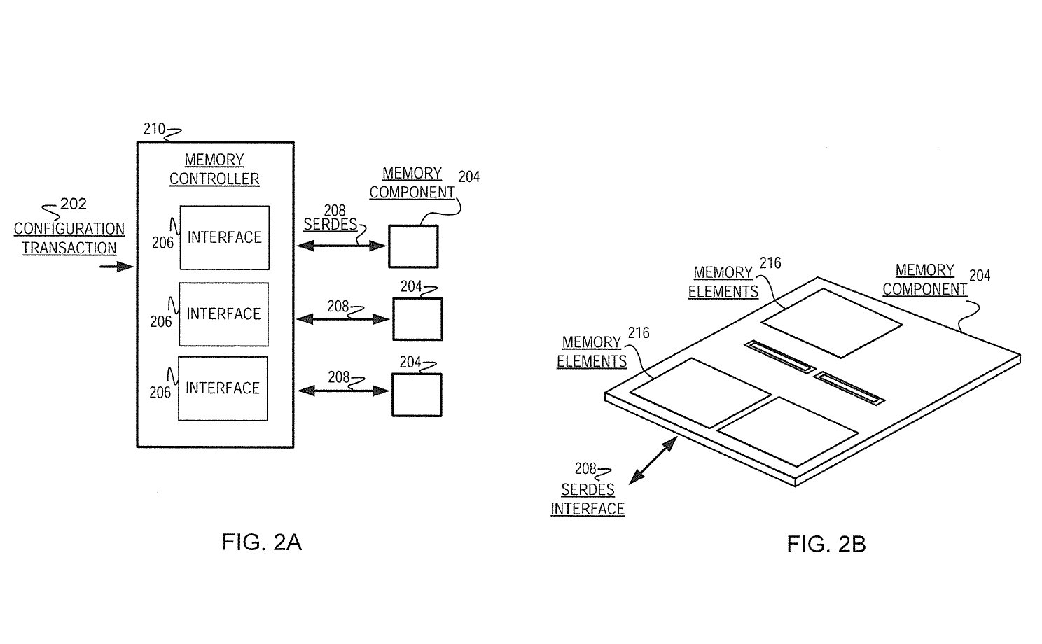

FIG. 2A is a block diagram of an example memory controller 210 including interfaces 206 to multiple memory components 204 through a Serializer/Deserializer (SerDes) interface 208. The SerDes interface 208 is used in each direction between the controller 210 and each of the memory components 204 to convert data between serial and parallel formats. In this implementation, the SerDes interface 208 is a type of interface between the controller 210 and each memory component 204 and as such, is independent of the interfaces 206 of the memory controller 210, memory elements 216, and/or memory arrays. Each of the interfaces 206 may be configured in addition to configuring the data width of SERDES interface 208. The interfaces 206 may be similar in structure and functionality to the interface 106 as in FIG. 1. The memory controller 210 manages the functions and operations of the multiple memory components 204. The memory controller 210 may be similar in structure and functionality to the memory controller 110 as in FIG. 1. Although FIG. 2A illustrates the memory controller 210 with multiple interfaces 206 this was done for illustration purposes as the memory controller 210 may include a single interface as in FIG. 1.

The memory controller 210 receives a configuration transaction 202 which specifies a data width (i.e. number of data bit values) in which to read and/or write various values of data to the memory components 204. The number of data bit values may be an arbitrary number of values and as such, in one implementation, the number of data bit values may be a non-power of two number (i.e., odd-numbered value). For example, this may include 3, 5, 7, etc. In another implementation, the configuration transaction 202 may be generated from within the memory controller 210 to configure the data width of each of the memory components 204.

The memory controller 210 uses multiple SerDes interfaces 208 to interface to each memory component 204. The data exchange between the memory controller 210 and each memory component 204 may include read and write transactions in addition to the configuration transaction 202. In this implementation, the configuration transaction 202 is received by the memory controller 210 to configure the data width of each memory component 204. Thus, the data width of one of the memory components 204 may be configured to write and/or read data bit values to that configured data width. Although FIG. 2A illustrates the memory controller 210 including three SerDes interfaces 208 to the memory components 204 for configuring, reading and writing data values to each of the memory components 204, implementations should be not limited as this was done for illustration purposes. For example, the memory controller 210 may include a single SerDes 208 interface to the memory components 204.

Each memory component 204 may include one or multiple memory elements 216, such as an array of memristor, which may be programmed to store multiple data bit values. For example, a data bit value of “0,” includes a low voltage stored at one of the memory elements 216, a data bit value of “1,” includes a high voltage stored at one of the memory elements 216. In a further example, each of the memory elements 216 may be programmed with a resistance to correspond to the data bit values. In one implementation, each memory element 216 as used herein may include multiple data bit values rather than a single data bit value. In another implementation, each memory element 216 may include a single data bit value as in the earlier referenced example.

FIG. 2B is a block diagram of an example memory component 204 including multiple memory elements 216. The memory component 204 communicates through a serializer/deserializer (SerDes) interface 208 to the controller 210 as in FIG. 2A. The memory controller 210 receives the configuration transaction 202 and configures the data width between the memory elements 216 as part of the memory component 204. In this manner, the memory component 204 is configured to one of multiple data widths. Although FIG. 2B illustrates the memory component 204 as including multiple memory elements 216, implementations should not be limited as this was done for illustration purposes. For example, the memory component 204 may include a single memory element 216.

The SerDes interface 208 is connected between the memory component 204 and the memory controller 210. The memory component 204 is configured to a particular data width based on the configuration transaction 202 received by the memory controller 210. Once configuring the memory component 204 to the particular data width, the SerDes interface 208 may interface to the memory component 204 to read and write various data bit values based on additional received transactions indicating whether to read and/or write these data bit values. The configuration transaction 202 indicates the size of the data width for receiving and transmitting data bit values in the read and write transactions. In one implementation, the configuration transaction 202 is transmitted from an external controller (not illustrated) and received by the memory controller 210, while another implementation includes the configuration transaction 202 generated from within the memory controller 210.

The memory component 204 is configured with the data width associated with the configuration transaction 202. In one implementation, the memory component 204 configures the data width to each of the memory elements 216 through which to read and write the data bit values. Receiving the configuration transaction 202 by the memory controller 210 provides the memory component 204 flexibility to internally configure itself to various data widths to support high speed communications.

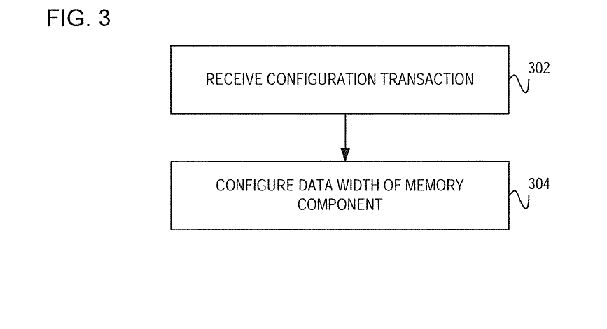

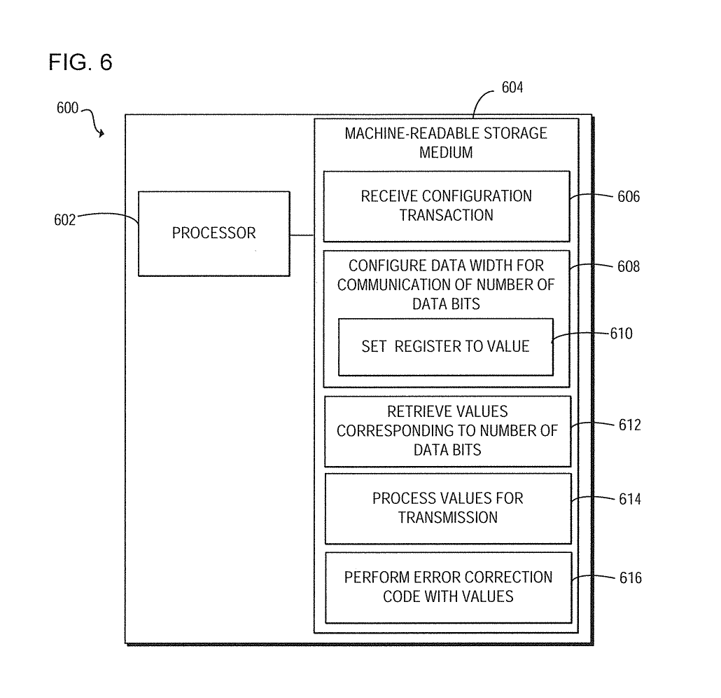

FIG. 3 is a flowchart of an example method to receive a configuration transaction associated with a number of bits and configure a data width of a memory component based on the number of bits from the received configuration transaction. Configuring the data width of the memory component based on the configuration transaction enables system designers to select a memory configuration to best meet the needs of the memory systems requirements. In discussing FIG. 3, references may be made to the components in FIGS. 1-2B to provide contextual examples. Further, although FIG. 3 is described as implemented by a memory component 104 as in FIG. 1, it may be executed on other suitable components. For example, FIG. 3 may be implemented in the form of executable instructions on a machine readable storage medium, such as machine-readable storage medium 604 as in FIG. 6.

At operation 302, the memory component receives the configuration transaction. The configuration transaction may be delivered from a controller over an interface to the memory component for configuring the data width of the memory component. This provides an additional flexibility without redesigning the memory system to accommodate various data widths for communications. The configuration transaction is associated with a number of data bits which corresponds to the data width for configuring the memory component for reading and writing data bit values from internal storage on the memory component. Adjusting the data width of the memory component based on the configuration transaction allows a common memory component to be tuned to provide just the data bits required for various applications, increasing usable bandwidth, with the low transfer latency and power consumption per transferred data bit. The configuration transaction is a signal transferred from a controller over an interface to the memory component. In one implementation, the received configuration transaction may include the data width in which to configure the memory component. The memory component may receive an additional transaction indicating whether to read or write data bit values using the data width as configured by the configuration transaction.

At operation 304, the memory component configures the data width for communication based on the configuration transaction received at operation 302. The data width may include a value specified as data bits and/or data bytes. In one implementation, the data width may be configured to a non-power of two value (e.g., not 1, 2, 4, 8, 16, etc.). For example, the data width may include an odd numbered value such as 3, 5, 7, etc. In another implementation, a register internal to the memory component is set to a value corresponding to the data width to read and/or write the values of the data bits transferred back and forth from the memory component. Additionally, in another implementation, the received configuration transaction at operation 302 may include an address configuration. The address configuration indicates how the address provided in a read or write operation should be interpreted to indicate a memory location, or address, targeted by the read or write operation. In a further implementation, the configuration transaction may be included as part of a boot-up sequence and/or side channel selection of the memory component. In this implementation, the received configuration transaction may include an initial transaction. The initial transaction instructs the memory component to configure itself to a data width by setting internal values of register(s) and indicates the data width for receiving and transmitting values of data bits corresponding to the data width. In a further implementation, the configuration transaction may include a configuration address which the memory component may identify as the configuration specifying the data width which to set itself. In yet another implementation, the memory component may be configured through a side-band signal. In this implementation, an additional port is included as part of the memory component with lower frequencies and capability to transmit the configuration transaction until the memory component resumes normal operation of reading and/or writing data bit values. In further implementations, the memory component may be configured to access data bit values of a given data width with additional configuration information. The additional configuration information indicates to the memory component to perform a correction function, such as an error correction code on the accessed values of data bits. In these further implementations, the values of the data bits transferred to the controller from the memory component over the interface may include a fewer number of data bit values than the number of data bit values accessed from within the memory component. In addition to configuring the memory component, the interface may also be configured to provide the capability of supporting the data width of the received configuration transaction through which to transfer the data bit values corresponding to the data width over the interface. In this implementation, the controller may establish communication with the interface to establish the number of channels through which to transfer the data and/or the number of cycles on each of the channels. This implementation is explained in further detail in the next figure.

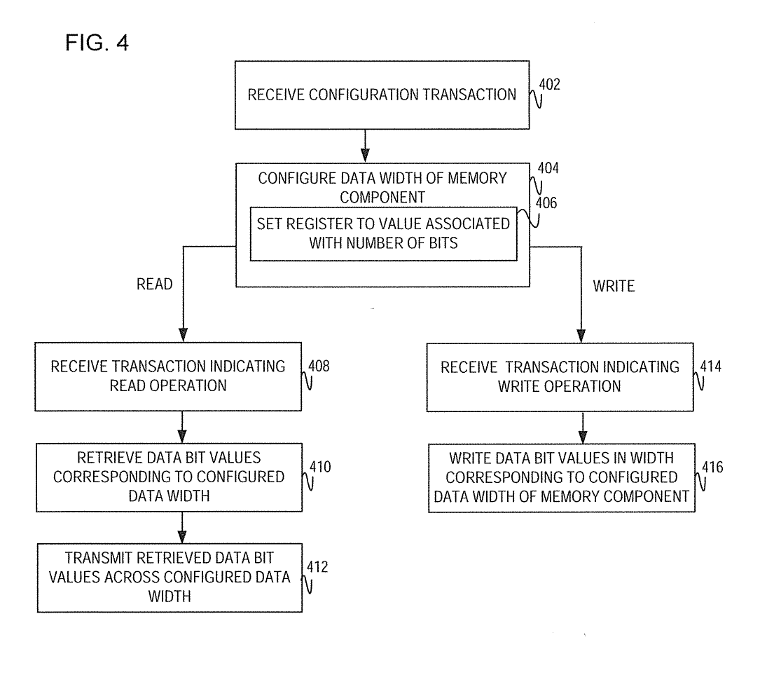

FIG. 4 is a flowchart of an example method to method to receive a configuration transaction associated with a number of data bits and configure a data width of a memory component by setting an internal register of the memory component to a value corresponding to the number of data bits. Additionally, FIG. 4 illustrates receiving a read or write transaction and processing that transaction across the data width specified by the data width configuration transaction. Setting the internal register to the memory component based on the configuration transaction enables utilization of multiple memory components to promote higher speed capacity of reading and/or writing values of data bits. In discussing FIG. 4, references may be made to the components in FIGS. 1-2B to provide contextual examples. Further, although FIG. 4 is described as implemented by a memory component 104 as in FIG. 1, it may be executed on other suitable components. For example, FIG. 4 may be implemented in the form of executable instructions on a machine readable storage medium, such as machine-readable storage medium 604 as in FIG. 6.

At operations 402-404, the memory component receives the configuration transaction associated with configuring a number of data bits. The number of data bits corresponds to the data width in which to configure the memory component at operation 404 for communicating values of the data bits over an interface. For example, the configuration transaction configures the data width of the memory component for receiving additional transactions. The additional transactions may include read and write operations as indicated at operations 408-416. The configured data width at operation 404 defines the width or number of data bits accessed through read or write transactions. In one implementation, once performing operations 402-404, the method performs operation 406 and then operations 408-412 to read values of data bits corresponding to the data width. In another implementation, once performing operations 402-404, the method performs operation 406 and then operations 414-416 to write values of the data bits corresponding to the data width. Operations 402-404 may be similar in functionality to operations 302-304 as in FIG. 3.

At operation 406, the memory component configures the data width by setting the internal register to a value corresponding to the data width. The memory component transmits a signal to the internal register to set the value to the number of data bits associated with the configuration transaction received at operation 402. The data width corresponds to the value to the number of data bits for the memory component to communicate with other internal memory components.

At operation 408, the memory component receives the additional transaction indicating a read operation for the memory component. The read operation at operation 408, enables the memory component to retrieve the data bit values at the configured data width as at operation 404. In another implementation, the read operation enables the memory component to retrieve the data bit values at operation 410.

At operation 410, the memory component retrieves the values of data bits corresponding to the configured data width. At this operation, the memory component may receive the read operation as at operation 408 and after receiving this read operation, the memory component may retrieve the data bit values from memory elements internal to the memory component, such as an array. The read operation may include an address in which to retrieve the data bit values from a memory element internal to the memory component. The data width size of the read operation in which retrieve data bit values is configured by the configuration transaction received at operation 402.

At operation 412, the memory component transmits the values of the data bits retrieved at operation 410. In one implementation, a correction function is performed on the retrieved values of the data bits. This ensures the values retrieved from a particular location are without corruption or error. This implementation is explained in detail in the next figure.

At operations 414-416, the memory component receives a transaction indicating a write operation. The transaction may provide address and data indicating to the memory component to write the data to memory elements internal to the memory component indicated by the provided address. The write operation of the data bit values corresponds in width to the configured data width of the memory component as at operation 404.

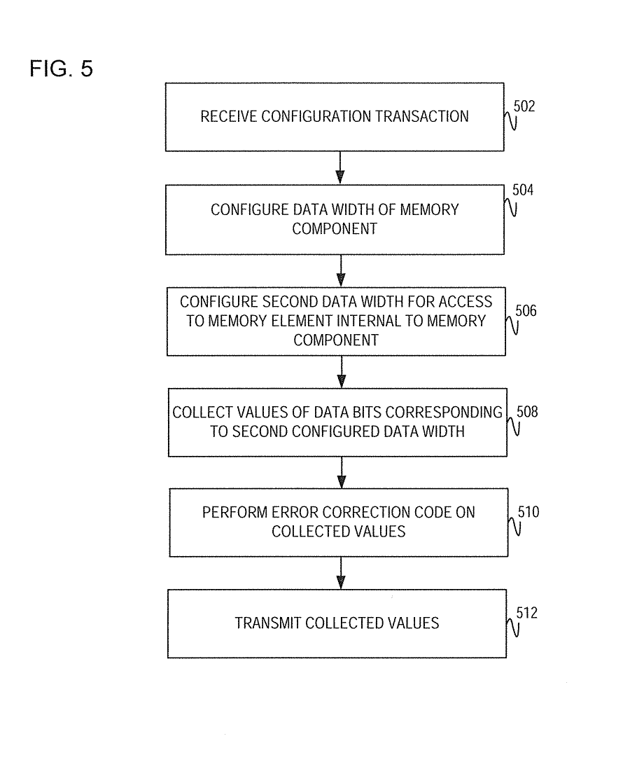

FIG. 5 is a flowchart of an example method to receive a configuration transaction and configure a data width of the memory component based on the configuration transaction. The method further configures a second data width for access to a memory element internal to the memory component and collects data bit values corresponding to the second configured data width. The method may then perform an error correction code on the collected values and transmit these collected values. Performing an error correction on the collected values of the data bits corresponding to the data width enables fewer values of data bits transmitted over an interface, thus increasing a higher speed to transfer values of data bits. In discussing FIG. 5, references may be made to the components in FIGS. 1-2B to provide contextual examples. Further, although FIG. 4 is described as implemented by a memory component 104 as in FIG. 1, it may be executed on other suitable components. For example, FIG. 5 may be implemented in the form of executable instructions on a machine readable storage medium, such as machine-readable storage medium 604 as in FIG. 6. Operations 502-504 may be similar in functionality to operations 302-304 and 402-404 as in FIGS. 3-4, respectively.

At operation 506, the memory component configures the second data width for access to at least one of the memory elements internal to the memory component. In one implementation, the second data width is considered wider than the configured data width of the memory component at operation 504. This implementation enables more data bit values to be collected and processed for performing the error correction code at operations 508-510. This further enables the error correcting code performed on the memory component and transmits fewer collected data bit values such as at operation 512. Operation 506 includes the memory component configuring an internal interface in which to retrieve and/or collect data bit values from the memory elements on the memory component. The configured data width at operation 504 is the width in which to collect and/or transmit data bit values. The collection and/or transmission of the data bit values are based on additional transactions indicating the read and/or write operation. These operations are received after the configuration transaction at operation 502. The second configured data width is the data width in which to retrieve and/or collect the data bit values from memory element(s) internal to the memory component.

At operation 508, the memory component collects the data bit values from internal memory elements, such as arrays. The memory component collects a number of data bit values which corresponds to the second configured data width as at operation 506. The data bit values collected internally correspond to the second configured data width. In one implementation, these data bit values corresponding to the second configured data width may then be transmitted according to the configured data width of the memory component. The data bit values collected from the internal storage memory element are considered the raw bits of data as the values are retrieved directly from the internal storage element without processing. In one implementation, the raw bits of data are processed in accordance with an error correction code as at operation 510.

At operation 510, the memory component performs an error correction code on the values of the data bits collected at operation 508. The error correction code is set of redundant values of data bits are considered parity data bits used to verify the collected values of data bits at operation 508 are valid. Performing the error correction code at the memory component improves bandwidth and latency as the values of data bits requested by the controller are transferred back, rather than requested data bit values and the additional redundant data bits. In one implementation, the controller receives the error correction code and values of the data bit values to perform the error correcting code to ensure the values of the data bits are without corruption. At operation 510, the collected data bit values and the redundant data bit values may be stored in memory elements, such as a storage array. This storage array may include an increased storage capacity area within the memory component to store both the redundant data bit values and the data bit values than the internal memory elements from which to collect the data bit values.

At operation 512, the corrected values of the data bits provide at operation 510 are transmitted over the interface to the controller. In one implementation, the raw values of the data bits are collected and transmitted to the controller without performing the error correction code as at operation 510. This enables the controller to perform the error correction code.

FIG. 6 is a block diagram of computing device 600 with a processor 602 to execute instructions 606-616 within a machine-readable storage medium 604. Specifically, the computing device 600 with the processor 602 is to receive a configuration transaction and configure a data width corresponding to a number of data bits based on the configuration transaction. Although the computing device 600 includes processor 602 and machine-readable storage medium 604, it may also include other components that would be suitable to one skilled in the art. For example, the computing device 600 may include the memory component 104 and/or interface 106 as in FIG. 1. The computing device 600 is an electronic device with the processor 602 capable of executing instructions 606-616, and as such embodiments of the computing device 600 include a computing device, mobile device, client device, personal computer, desktop computer, laptop, tablet, video game console, or other type of electronic device capable of executing instructions 606-616. The instructions 606-616 may be implemented as methods, functions, operations, and other processes implemented as machine-readable instructions stored on the storage medium 604, which may be non-transitory, such as hardware storage devices (e.g., random access memory (RAM), read only memory (ROM), erasable programmable ROM, electrically erasable ROM, hard drives, and flash memory.

The processor 602 may fetch, decode, and execute instructions 606-616 to receive a configuration transaction and configure the data width accordingly. In one implementation, once executing instructions 606-610, the processor may then execute instructions 612-614. In another implementation, once executing instructions 606-610, the processor 602 may then execute instructions 612-616. Specifically, the processor 602 executes instructions 606-610 to: receive the configuration transaction indicating the number of data bits corresponding to the data width of the memory component for communication; configure the data width of the memory component for communication based on the number of data bits; and set a register internal to the memory component to a value corresponding to the number of data bits for configuration. The processor may then execute instructions 612-616 to: retrieve values corresponding to the number of data bits associated with the configuration transaction at instructions 606; process the values of the data bits for transmission; and then perform an error correction code or other type of correction code on the retrieved values of data bits prior to transmission.

The machine-readable storage medium 604 includes instructions 606-616 for the processor to fetch, decode, and execute. In another implementation, the machine-readable storage medium 604 may be an electronic, magnetic, optical, memory, storage, flash-drive, or other physical device that contains or stores executable instructions. Thus, the machine-readable storage medium 604 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 604 may include an application and/or firmware which can be utilized independently and/or in conjunction with the processor 602 to fetch, decode, and/or execute instructions of the machine-readable storage medium 604. The application and/or firmware may be stored on the machine-readable storage medium 604 and/or stored on another location of the computing device 600.

In summary, examples disclosed herein provide a flexible approach by configuring a data width of a memory component based on a configuration transaction. Additionally, the examples disclosed herein lead to higher efficiency by adjusting the data width of the memory component.

We claim:

1. A method, executable by a computing device to configure a data width of a memory component, the method comprising:
receiving a configuration transaction at the memory component capable to communicate at multiple data widths; and
configuring the data width of the memory component based on the configuration transaction.

2. The method of claim 1 wherein configuring the data width of the memory component based on the configuration transaction is further comprising:
setting a register internal to the memory component to a value associated with a number of data bits corresponding to the data width.

3. The method of claim 1 further comprising:
receiving, by the memory component, a second transaction; and
configuring an interface for communication between the memory component and the controller.

4. The method of claim 3 further comprising:
retrieving values of data bits corresponding to the configured data width based upon the second transaction indicating a read operation; and
transmitting the retrieved values of data bits to the controller over the interface.

5. The method of claim 1 further comprising:
configuring a second data width for access to memory elements internal to the memory component, wherein the second data width is a wider data width than the configured data width; and
collecting values of data bits corresponding to the second configured data width from the memory elements internal to the memory component.

6. The method of claim 5 further comprising:
performing a correction function on the collected values of data bits to generate corrected values of data bits; and
transmitting the corrected values of data bits over an interface to a controller.

7. A memory component comprising:
a memory controller to receive a configuration transaction over an interface, the configuration transaction associated with a number of data bits corresponding to a data width of the memory component, and wherein the memory component is capable to communicate at multiple data widths;
a register to set an internal value to the number of data bits corresponding to the data width; and
an array to provide values of the number of the data bits for communication across the interface.

8. The memory component of claim 7 wherein the configuration transaction indicates a number of cycles and a number of channels through which to transmit the values of the number of data bits from the memory component.

9. The memory component of claim 7 wherein the interface is a serializer and deserializer (SerDes) interface and a link width of the interface corresponds to the data width of the memory component.

10. The memory component of claim 7 wherein the number of data bits corresponding to the data width of the memory components is an non-power of two number of data bits.

11. The memory component of claim 7 wherein the memory controller is further to:
indicate an address associated with a value of the data width.

12. A non-transitory machine-readable storage medium encoded with instructions executable by a processor of a computing device, the storage medium comprising instructions to:
receive a configuration transaction by a memory component capable to communicate at multiple data widths, the configuration transaction indicating a number of data bits corresponding to a data width of the memory component; and
configure the data width of the memory component for communication using the number of data bits associated with the data width of the memory component, the data width based on the configuration transaction.

13. The non-transitory machine-readable storage medium including the instructions of claim 12 and further comprising instructions to:
retrieve values corresponding to the number of data bits from an address of memory elements internal to the memory component; and
process the values for transmission across an interface.

14. The non-transitory machine-readable storage medium including the instructions of claim 12 wherein to configure the data width of the memory component to the number of data bits based on the configuration transaction is further comprising instructions to:
set a register internal to the memory component to a value of corresponding to the number of data bits.

15. The non-transitory machine-readable storage medium including the instructions of claim 12 and further comprising instructions to:
perform an error correction code with values of the number of data bits prior to transmission.
